(19) United States
(12) Patent Application Publication
(10) Pub. No.: US 2026/0237621 A1
(43) Pub. Date: Aug. 13, 2026

(54) MULTI-SOURCE MASS SPECTRAL DATA COMBINATION

(71) Applicant: Thermo Fisher Scientific (Bremen) GmbH, Bremen (DE)

(72) Inventors: Hamish Stewart, Bremen (DE); Alexander Makarov, Bremen (DE)

(21) Appl. No.: 19/451,306

(22) Filed: Jan. 16, 2026

(30) Foreign Application Priority Data
Feb. 13, 2025 (GB) GB2502134.6
Feb. 27, 2025 (GB) GB2502869.7

(51) Int. Cl. H01J 49/00

(52) U.S. Cl. CPC H01J 49/0036; H01J 49/004

(57) ABSTRACT

A method of processing mass spectral data is provided. The method comprises: identifying one or more ion peaks in the first set of mass spectral data, identifying one or more ion peaks in the second set of mass spectral data, and identifying one or more features in the mass spectral data by comparing peak(s) identified in the first set of mass spectral data with peak(s) identified in the second set of mass spectral data and storing data describing each identified feature. The step of storing data comprises: storing value(s) of at least one property of the one or more first properties and value(s) of at least one different property of the one or more second properties to describe the at least one identified feature.

### CROSS-REFERENCE TO RELATED APPLICATIONS

This application claims the benefit under 35 U.S.C. § 119(b) of United Kingdom Application no. GB2502134.6 filed Feb. 13, 2025 and United Kingdom Application no. GB2502869.7 filed Feb. 7, 2025, the entire contents of each of which are incorporated herein by reference.

### FIELD

The present invention relates to the field of mass spectrometry, and more particularly to methods of processing mass spectral data.

### BACKGROUND

Mass spectrometry is a sensitive technique in which a mass analyser is used to measure the mass-to-charge ratio (m/z) of ions generated from a sample to identify and quantify compounds present in the sample. Several mass analyser technologies exist, each of which has its own advantages and limitations. For example, the Orbitrap™ mass analyser can slowly generate very high resolution, mass accurate spectra, while the Astral™ mass analyser cannot quite match the Orbitrap™ in these regards but is much faster and more sensitive.

The Thermo Scientific™ Orbitrap™ Astral™ mass spectrometer (Stewart, H. et al., Anal. Chem., 2023, 95 (42), 15656-15664) combines both an Orbitrap™ mass analyser and an Astral™ mass analyser in order to provide the benefits of each analyser in a single instrument. Typically, the Orbitrap™ analyser is used to make high quality analyte survey scans (Full-MS or MS1) while the Astral™ analyser operates in parallel to generate rapid and sensitive MS/MS (MS2) fragmentation scans, that fingerprint the analytes and allow for their identification. Another successful family of multi-analyser hybrid instruments are the Thermo Scientific™ Tribrid™ mass spectrometers (Senko, M. et al., Anal. Chem., 2013, 85 (24), 11710-11714), that combine an Orbitrap™ mass analyser and an extremely sensitive ion trap analyser, along with a quadrupole mass filter.

In addition to the different performance envelopes of different mass analyser technologies, different analyser settings or modes of operation will change each analyser's performance. For example, an Orbitrap™ mass analyser's resolving power and signal to noise ratio depend on the transient time (or length of analysis), and so there is a trade-off between quality and repetition rate. Changing the amplitude of the RF voltage applied to the “C-Trap” (that accumulates ions and injects them into the Orbitrap™ mass analyser) will change the m/z range that can be efficiently trapped. Increasing the gain of an ion detector might increase the sensitivity to low lying signals but will reduce the number of ions at which signal saturation takes place.

It is known that spectral peaks from different sources can be combined to generate a superior stitched spectrum. For example, it is increasingly common in time-of-flight mass analysers to combine peaks taken from two different detector channels with differing gain, such that high sensitivity and high saturation threshold can be provided in a single stitched spectrum (Beavis, R. C., Anal. Chem., 1996, 7, 107-113).

UK Patent Application No. GB 2,626,803 describes a method of building precursor ion lists using ion peaks taken from different analysers. When combining Orbitrap™ analyser and Astral™ analyser survey scan (MS1) data, low intensity peaks can be taken from the more sensitive Astral™ analyser data and high intensity peaks from the more mass accurate, saturation resistant Orbitrap™ analyser data. This has the effect of increasing the dynamic range of survey scans used to generate target data for follow-up MS/MS (MS2) analysis.

U.S. Pat. No. 10,593,525 describes a method of calibrating a ToF-MS mass spectrum to account for temperature changes, based on data from a Fourier Transform (FT) mass analyser.

It is believed that there remains scope for improvements to apparatus and methods for processing mass spectral data.

### SUMMARY

A first aspect provides a method of processing mass spectral data that comprises a first set of mass spectral data acquired from a first source of mass spectral data and a second set of mass spectral data acquired from a second source of mass spectral data, the method comprising:
identifying one or more ion peaks in the first set of mass spectral data, and for each of one or more ion peaks identified in the first set of mass spectral data: determining value(s) of one or more first properties of that ion peak;
identifying one or more ion peaks in the second set of mass spectral data, and for each of one or more ion peaks identified in the second set of mass spectral data: determining value(s) of one or more second properties of that ion peak;
identifying one or more features in the mass spectral data by comparing peak(s) identified in the first set of mass spectral data with peak(s) identified in the second set of mass spectral data; and
storing data describing each identified feature;
wherein, for at least one identified feature that comprises one or more first ion peak(s) identified in the first set of mass spectral data and one or more corresponding second ion peak(s) identified in the second set of mass spectral data, the step of storing data comprises: storing value(s) of at least one property of the one or more first properties and value(s) of at least one different property of the one or more second properties to describe the at least one identified feature.

Embodiments provide a method of processing mass spectral data taken from first and second sources of mass spectral data. The first and second sources of mass spectral data may be two different mass analysers of different types, two different mass analysers of the same type operated in two different modes of operation, or may be the same mass analyser operated in two different modes of operation. The first and second sets of mass spectral data may be acquired by analysing groups of ions that have the same or similar distributions of ion species, i.e. so that the first and second sets of mass spectral data include ion peaks representative of the same or similar set(s) of ion species.

In the method, mass spectral data acquired from the first and second sources is firstly processed to identify peaks in each of the first and second sets of mass spectral data, and value(s) of one or more properties of each ion peak are determined. The one or more properties can include at least a centroid (which may correspond to a mass to charge ratio (m/z)) and a measure of intensity for each peak (e.g. peak height or area, etc.), optionally together with one or more other properties such as effective resolving power, polarity, charge state, collision cross section (CCS), signal to noise ratio (s/n), peak fidelity, etc.

Then, features in the mass spectral data are identified by comparing the peaks identified in the first set of mass spectral data with the peaks identified in the second set of mass spectral data; and for each identified feature, data describing that feature is stored, e.g. in a memory provided in association with a control system of the analytical instrument. As used herein a “feature” can be a group of one or more ion peak(s) identified in the first set of data and one or more corresponding ion peak(s) identified in the second set of data, i.e. one or more ion peak(s) from the first set of data and one or more peaks(s) from the second set of data that are representative of the same ion species or set of ion species. A “feature” can also be one or more ion peak(s) in the first set of data that has no corresponding peak(s) in the second set of data, or one or more ion peak(s) in the second set of data that has no corresponding peak(s) in the first set of data.

In the method, for one or more or each feature that comprises one or more ion peak(s) from the first set of mass spectral data and one or more corresponding ion peak(s) from the second set of mass spectral data, when storing data describing that feature, value(s) for at least one first property as determined using the first set of mass spectral data is/are stored together with (in association with) value(s) for at least one other different second property as determined using the second set of mass spectral data (and any value(s) for the at least one first property as determined using the second set of mass spectral data and any value(s) for the at least one other different second property as determined using the first set of mass spectral data are discarded, and are not stored for that feature). For example, for each such feature, the stored centroid (i.e. m/z) value(s) may be the value(s) as determined from the first set of mass spectral data (and any centroid value(s) as determined from the second set of mass spectral data are discarded, i.e. are not stored), whereas the stored intensity value(s) may be the value(s) as determined from the second set of mass spectral (and any intensity value(s) as determined from the first set of mass spectral data are discarded, i.e. are not stored).

Thus, in embodiments, property values as determined from the two sets of mass spectral data are mixed and stored in respect of individual features (e.g. individual peaks). This is in contrast with known methods of combining data taken from multiple sources, in which each individual peak (and all of its property values) is taken from a single source of mass spectral data.

As will be described in more detail below, by mixing property values for each feature (e.g. each peak) as determined from mass spectral data acquired from different sources, the best properties from each source can be used, thereby producing high quality mass spectra. There is also a benefit in terms of data compression by filtering out or combining otherwise redundant data.

It will accordingly be appreciated that embodiments provide an improved method of processing mass spectral data.

The first source of mass spectral data may comprise a first mass analyser of a first type and the second source of mass spectral data may comprise a second mass analyser of a second different type.

Alternatively, the first source of mass spectral data may comprise a first mass analyser of a first type operated in a first mode of operation, and the second source of mass spectral data may comprise either: (i) the first mass analyser operated in a second different mode of operation; or (ii) a second mass analyser of the first type operated in a second different mode of operation.

The first mass analyser type may comprise any suitable type of mass analyser, such as a Fourier Transform (FT) mass analyser, an ion trap mass analyser, an electrostatic orbital trap mass analyser, a time-of-flight (ToF) mass analyser, a multi-reflecting time-of-flight (MR-ToF) mass analyser, or a quadrupole mass analyser. Equally, the second mass analyser type may comprise any suitable type of mass analyser, such as a Fourier Transform (FT) mass analyser, an ion trap mass analyser, an electrostatic orbital trap mass analyser, a time-of-flight (ToF) mass analyser, a multi-reflecting time-of-flight (MR-ToF) mass analyser, or a quadrupole mass analyser.

In embodiments, the first mass analyser is a Fourier Transform (FT) mass analyser, and the second mass analyser is a time-of-flight (ToF) mass analyser or a multi-reflecting time-of-flight (MR-ToF) mass analyser.

The first set of mass spectral data may be acquired by analysing a first group of ions, and the second set of mass spectral data may be acquired by analysing a second different group of ions. The first and second groups of ions may have the same or similar distributions of ion species, i.e. so that ion peaks representative of some, most or all ion species for which ion peaks appear in the first set of mass spectral data also appear in the second set of mass spectral data. The first and second sets of mass spectral data may be acquired substantially in parallel (e.g. at the same time, or during substantially consecutive time periods) in respect of the same sample and/or the same flow of ions. Thus, the first and second mass analysers (or the first mass analyser in its two modes of operation) may be configured to acquire the first and second sets of mass spectral data substantially in parallel in respect of the same sample and/or the same flow of ions, e.g. from the same ion source.

The first and second sets of mass spectral data may be acquired with high resolution and accurate mass. For example, the first and/or second mass analyser may each have a mass accuracy ≤about 100 ppm, ≤about 50 ppm, ≤about 20 ppm, or ≤about 10 ppm, and a resolving power (at 200 m/z) ≥about 5,000, ≥about 10,000, ≥about 20,000, ≥about 50,000, or ≥about 100,000. The first and second sets of mass spectral data may be acquired with the same or different acquisition rates. In embodiments, the first mass analyser is configured to acquire data a first rate, and the second mass analyser (or the first mass analyser operating in its second mode of operation) is configured to acquire data a second different rate.

The one or more first properties that are determined for each peak identified in the first set of mass spectral data may comprise any one or more or each of: a centroid, intensity, effective resolving power, width, polarity, charge state, collision cross section, signal to noise ratio, and peak fidelity. Equally, the one or more second properties that are determined for each peak identified in the second set of mass spectral data may comprise any one or more or each of: a centroid, intensity, effective resolving power, width, polarity, charge state, collision cross section, signal to noise ratio, and peak fidelity.

The one or more first properties that are determined for each peak identified in the first set of mass spectral data may be the same as the one or more second properties that are determined for each peak identified in the second set of mass spectral data. In this case, there may be a plurality of first properties and a plurality of second properties (and the at least one property of the one or more first properties for which value(s) are stored is/are different to the at least one property of the one or more second properties for which value(s) are stored). Alternatively, the one or more first properties that are determined for each peak identified in the first set of mass spectral data may be a different (overlapping or non-overlapping) set of one or more properties than the one or more second properties that are determined for each peak identified in the second set of mass spectral data. In this case, one or more first properties may be determined for each peak identified in the first set of mass spectral data and/or one or more second properties may be determined for each peak identified in the second set of mass spectral data (where the at least one property of the one or more first properties for which value(s) are stored is/are different to the at least one property of the one or more second properties for which value(s) are stored).

The at least one property of the one or more first properties for which value(s) are stored and the at least one different property of the one or more second properties for which value(s) are stored may be selected based on relative performance of the first and second sources of mass spectral data. For each property for which value(s) are stored, values in respect of that property may be taken from whichever one of the first and second sources of data that has highest performance in respect of that property (and values in respect of that property determined using the other source may be discarded).

The step of identifying one or more features in the mass spectral data may comprise, for each of one or more ion peaks identified in the first set of mass spectral data: determining whether the ion peak corresponds to one or more ion peak(s) identified in the second set of mass spectral data; and identifying a feature when it is determined that an ion peak identified in the first set of mass spectral data corresponds to one or more ion peak(s) identified in the second set of mass spectral data. In this case, the identified feature will comprise the ion peak identified in the first set of mass spectral data and the corresponding one or more ion peak(s) identified in the second set of mass spectral data.

Additionally or alternatively, the step of identifying one or more features in the mass spectral data may comprise, for each of one or more ion peaks identified in the second set of mass spectral data:
determining whether the ion peak corresponds to one or more ion peak(s) identified in the first set of mass spectral data; and identifying a feature when it is determined that an ion peak identified in the second set of mass spectral data corresponds to one or more ion peak(s) identified in the first set of mass spectral data. In this case, the identified feature will comprise the ion peak identified in the second set of mass spectral data and the corresponding one or more ion peak(s) identified in the first set of mass spectral data.

When it is determined that an ion peak identified in the first set of mass spectral data does not correspond to any ion peak identified in the second set of mass spectral data, the method may comprise: determining whether the ion peak identified in the first set of mass spectral data is a feature or an artefact. Then, when it is determined that an ion peak is a feature, the method may comprise storing a value of at least one property of the one or more first properties to describe the feature. When it is determined that an ion peak is an artefact, the method may comprise discarding the ion peak without storing any data.

Additionally or alternatively, the method may comprise, when it is determined that an ion peak identified in the second set of mass spectral data does not correspond to any ion peak identified in the first set of mass spectral data: determining whether the ion peak identified in the second set of mass spectral data is a feature or an artefact. Then, when it is determined that the ion peak is a feature, the method may comprise storing a value of at least one of the one or more second properties to describe the feature. When it is determined that the ion peak is an artefact, the method may comprise discarding the ion peak without storing any data.

The at least one identified feature may comprise a single first ion peak identified in the first set of mass spectral data and a single corresponding second ion peak identified in the second set of mass spectral data. In this case, the method may comprise storing data describing the feature as a single peak, where the stored data comprises a value of the at least one property of the one or more first properties and a value of the at least one different property of the one or more second properties to describe the single peak.

Alternatively, the at least one identified feature may comprise one or more first ion peak(s) identified in the first set of mass spectral data and a plurality of corresponding second ion peaks identified in the second set of mass spectral data, or the feature may comprise a plurality of first ion peaks identified in the first set of mass spectral data and one or more corresponding second ion peak(s) identified in the second set of mass spectral data. In this case, the method may comprise storing values of the at least one property of the one or more first properties for all peaks in the feature and storing values of the at least one different property of the one or more second properties for all peaks in the feature.

The method may comprise not determining value(s) of the at least one property of the one or more first properties based on the second set of mass spectral data and/or not determining value(s) of the at least one different property of the one or more second properties based on the first set of mass spectral data. Additionally or alternatively, the method may comprise discarding any value(s) of the at least one property of the one or more first properties determined based on the second set of mass spectral data and/or discarding any value(s) of the at least one different property of the one or more second properties determined based on the first set of mass spectral data.

Thus, the method may comprise, for the at least one identified feature, storing data to describe that feature by: storing value(s) of at the least one property of the one or more first properties as determined from the first set of mass spectral data without storing any value(s) of that property as determined from the second set of mass spectral data; and storing value(s) of the at least one different property of the one or more second properties as determined from the second set of mass spectral data without storing any value(s) of that property as determined from the first set of mass spectral data. In other word, the stored data for the at least one identified feature may comprise value(s) of the at least one property of the one or more first properties as determined from the first set of mass spectral data, and value(s) of the at least one different property of the one or more second properties as determined from the second set of mass spectral data, without any value(s) of the at least one property of the one or more first properties as determined from the second set of mass spectral data, and without any value(s) of the at least one different property of the one or more second properties as determined from the first set of mass spectral data.

The step of storing data for the at least one identified feature may comprise: storing centroid value(s) as determined from the first set of mass spectral data and storing intensity value(s) as determined from the second set of mass spectral to describe the at least one identified feature (without storing centroid value(s) as determined from the second set of mass spectral data and without storing intensity value(s) as determined from the first set of mass spectral).

The method may comprise acquiring a plurality of first sets of mass spectral data and acquiring a plurality of second sets of mass spectral data, e.g. by repeatedly acquiring first sets of mass spectral data and repeatedly acquiring second sets of mass spectral data. The plurality of first sets of mass spectral data may be acquired with a first acquisition rate, and the plurality of second sets of mass spectral data may be acquired with a second acquisition rate, wherein the second acquisition rate is greater than the first acquisition rate.

In these embodiments, the method may comprise identifying one or more ion peaks in one or more third set(s) of mass spectral data acquired from the second source of mass spectral data, and for each of one or more ion peaks identified in each third set of mass spectral data: determining value(s) of one or more second properties of that ion peak. Then, the method may comprise updating the stored data describing the least one identified feature by storing intensity value(s) as determined from each third set of mass spectral to describe the at least one identified feature. In other words, intensity values as determined using the faster mass analyser may be used to update and/or may be appended to m/z values as determined using the slower mass analyser in respect of individual features (e.g. individual peaks), thereby in effect improving the time resolution of the slower analyser.

The at least one identified feature may comprise a plurality of first ion peaks that correspond to an isotopic cluster, and one or more corresponding second ion peak(s). In this case, the method may comprise:
storing centroid values for each of the plurality of first ion peaks as determined from the first set of mass spectral data;
determining a total intensity value for the one or more second ion peak(s) (e.g. by summing the intensity of each of the one or more second ion peak(s));
distributing the determined total intensity value among the plurality of first ion peaks to determine an intensity value for each of the plurality of first ion peaks (e.g. using a suitable distribution function for the isotopic cluster); and
storing the determined intensity value for each of the plurality of first ion peaks.

The method may be repeated in respect of each of plural features identified in the mass spectral data.

Another aspect provides a method of processing mass spectral data that comprises a first set of mass spectral data acquired from a first source of mass spectral data and a second set of mass spectral data acquired from a second source of mass spectral data, the method comprising:
identifying one or more ion peaks in the first set of mass spectral data, and for each of one or more ion peaks identified in the first set of mass spectral data: determining a value of a first property of that ion peak;
identifying one or more ion peaks in the second set of mass spectral data, and for each of one or more ion peaks identified in the second set of mass spectral data: determining a value of the first property of that ion peak;
identifying one or more features in the mass spectral data by comparing peak(s) identified in the first set of mass spectral data with peak(s) identified in the second set of mass spectral data; and
for each of one or more identified features: comparing value(s) of the first property as determined from the first set of mass spectral data to value(s) of the first property as determined from the second set of mass spectral data, and rescaling the first set of mass spectral data based on the comparison.

This aspect can, and in embodiments does, include any one or more or each of the optional features described herein.

In these embodiments, the first property can be mass to charge ratio (i.e. a centroid) or intensity. The rescaling may comprise shifting data points of the first set of mass spectral data based on difference(s) between corresponding centroids (or intensities). Then, after the rescaling, the value of the first property for each ion peak may be recalculated.

A further aspect provides a method of mass spectrometry comprising:
ionising a sample to produce sample ions;
mass analysing the sample ions or ions derived from the sample ions to obtain a first set of mass spectral data;
mass analysing the sample ions or ions derived from the sample ions to obtain a second set of mass spectral data; and
processing the mass spectral data using the method described above.

A further aspect provides a non-transitory computer readable storage medium storing computer software code which when executed on a processor performs the method(s) described above.

A further aspect provides a control system for an analytical instrument such as a mass spectrometer, the control system configured to cause the analytical instrument to perform the method(s) described above.

A further aspect provides an analytical instrument, such as a mass spectrometer, comprising the control system described above.

A further aspect provides an analytical instrument, such as a mass spectrometer, comprising:
an ion source configured to ionise a sample to produce sample ions;
one or more mass analyser(s) configured to mass analyse sample ions or ions derived from sample ions to acquire mass spectral data comprising a first set of mass spectral data acquired from a first source of mass spectral data and a second set of mass spectral data acquired from a second source of mass spectral data; and
a control system configured to process the mass spectral data by:
identifying one or more ion peaks in the first set of mass spectral data, and for each of one or more ion peaks identified in the first set of mass spectral data: determining value(s) of one or more first properties of that ion peak;
identifying one or more ion peaks in the second set of mass spectral data, and for each of one or more ion peaks identified in the second set of mass spectral data: determining value(s) of one or more second properties of that ion peak;
identifying one or more features in the mass spectral data by comparing peak(s) identified in the first set of mass spectral data with peak(s) identified in the second set of mass spectral data; and
storing data describing each identified feature;
wherein, for at least one identified feature that comprises one or more first ion peak(s) identified in the first set of mass spectral data and one or more corresponding second ion peak(s) identified in the second set of mass spectral data, the step of storing data comprises: storing value(s) of at least one property of the one or more first properties and value(s) of at least one different property of the one or more second properties to describe the at least one identified feature.

A further aspect provides an analytical instrument, such as a mass spectrometer, comprising:
an ion source configured to ionise a sample to produce sample ions;
one or more mass analyser(s) configured to mass analyse sample ions or ions derived from sample ions to acquire mass spectral data comprising a first set of mass spectral data acquired from a first source of mass spectral data and a second set of mass spectral data acquired from a second source of mass spectral data; and
a control system configured to process the mass spectral data by:
identifying one or more ion peaks in the first set of mass spectral data, and for each of one or more ion peaks identified in the first set of mass spectral data: determining a value of a first property of that ion peak;
identifying one or more ion peaks in the second set of mass spectral data, and for each of one or more ion peaks identified in the second set of mass spectral data: determining a value of the first property of that ion peak;
identifying one or more features in the mass spectral data by comparing peak(s) identified in the first set of mass spectral data with peak(s) identified in the second set of mass spectral data; and
for each of one or more identified features: comparing value(s) of the first property as determined from the first set of mass spectral data to value(s) of the first property as determined from the second set of mass spectral data, and rescaling the first set of mass spectral data based on the comparison.

These aspects can, and in embodiments do, include any one or more or each of the optional features described herein.

### BRIEF DESCRIPTION OF THE DRAWINGS

Various embodiments will now be described in more detail with reference to the accompanying Figures, in which:

FIG. 1 shows schematically an analytical instrument that may be configured to operate in accordance with embodiments;

FIG. 2 shows schematically detail of a mass spectrometer that may be configured to operate in accordance with embodiments;

FIG. 3 illustrates a method in accordance with embodiments in which mass spectra with different properties are generated and centroid data is merged;

FIG. 4 illustrates a method in accordance with embodiments; and

FIG. 5 illustrates a method of operating a mass spectrometer that may be used in embodiments.

### DETAILED DESCRIPTION

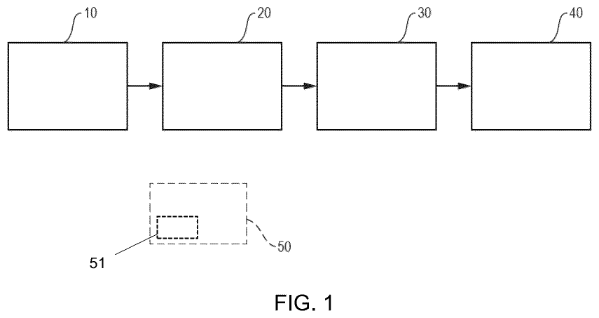

FIG. 1 illustrates schematically an analytical instrument, such as a mass spectrometer, that may be used in conjunction with the methods described herein. As shown in FIG. 1, the instrument includes an ion source 10, a mass filter 20, a fragmentation device 30, and a mass analyser 40.

The ion source 10 is configured to generate ions from a sample. The ion source 10 can be any suitable ion source, such as an electrospray ionisation (ESI) ion source, an atmospheric pressure ionisation (API) ion source, a chemical ionisation ion source, an electron impact (EI) ion source, or similar. Numerous other types of ionisation are possible. The ions may be any suitable type of ions to be analysed, e.g. small and large organic molecules, biomolecules, DNA, RNA, proteins, peptides, fragments thereof, and the like.

The ion source 10 may be coupled to a separation device (not shown) such as a liquid chromatography (LC) separation device, a gas chromatography (GC) separation device, or a capillary electrophoresis separation device, and the like, such that the sample which is ionised in the ion source 10 comes from the separation device.

The analytical instrument may additionally or alternatively include an ion separation device (not shown) arranged downstream of the ion source and configured to separate samples ions according to a physico-chemical property. For example, the instrument may include an ion mobility (IM) separator, a differential ion mobility separator, or a device configured to separate ions according to their mass to charge ratio (m/z)).

The mass filter 20 is arranged downstream of the ion source 10 and is configured to receive ions from the ion source 10 (optionally via the ion separation device). The mass filter 20 is configured to filter the received ions according to their mass to charge ratio (m/z). The mass filter 20 may be configured such that received ions having m/z within an m/z transmission window (or “isolation window”) of the mass filter are onwardly transmitted by the mass filter, while received ions having m/z outside the m/z transmission window are attenuated by the mass filter, i.e. are not onwardly transmitted by the mass filter. The width and/or the centre m/z of the transmission window may be controllable (variable), e.g. by suitable control of RF and/or DC voltage(s) applied to electrodes of the mass filter 20. Thus, for example, the mass filter 20 may be operable in a transmission (“non-resolving”) mode of operation, whereby most or all ions within a relatively wide m/z window are onwardly transmitted by the mass filter 20, and a filtering mode of operation, whereby only ions within a relatively narrow m/z window (centred at a desired m/z) are onwardly transmitted by the mass filter 20. The mass filter 20 can be any suitable type of mass filter, such as a quadrupole mass filter.

The fragmentation device 30 is arranged downstream of the mass filter 20 and is configured to receive most or all ions transmitted by the mass filter 20. The fragmentation device 30 may be configured to selectively fragment some or all of the received ions, i.e. so as to produce fragment ions. The fragmentation device 30 may be operable in a fragmentation mode of operation, whereby most or all received ions are fragmented so as to produce fragment ions (which may then be onwardly transmitted from the fragmentation device 30), and a non-fragmentation mode of operation, whereby most or all received ions are onwardly transmitted without being (deliberately) fragmented. It would also be possible for a non-fragmentation mode of operation to be implemented by causing ions to bypass the fragmentation device 30. The fragmentation device 30 may also be operable in one or more intermediate modes of operation, e.g. whereby the degree of fragmentation is controllable (variable). The instrument can also be operated in higher order (MS^{N}) fragmentation modes of operation, e.g. whereby fragment ions are further fragmented one or more times by the fragmentation device 30.

The fragmentation device 30 can be any suitable type of fragmentation device, such as for example a collision induced dissociation (CID) fragmentation device, an electron transfer dissociation (ETD) fragmentation device, an electron induced dissociation (EID) fragmentation device, a photodissociation fragmentation device, and so on. Numerous other types of fragmentation are possible.

The mass analyser 40 is arranged downstream of the fragmentation device 30 and is configured to receive ions from the fragmentation device 30. Thus, the mass analyser 40 may receive unfragmented precursor ions and/or fragment ions, depending on the mode of operation of the fragmentation device 30. The mass analyser 40 is configured to analyse the received ions so as to determine their mass to charge ratio (m/z) and/or mass, i.e. to produce a mass spectrum of the ions. The mass analyser 40 can be any suitable type of mass analyser, such as a Fourier Transform (FT) mass analyser, an ion trap mass analyser, an electrostatic orbital trap mass analyser (such as an Orbitrap™ FT mass analyser as made by Thermo Fisher Scientific), a time-of-flight (ToF) mass analyser such as a multi-reflecting time-of-flight (MR-ToF) mass analyser, or a quadrupole mass analyser. Numerous other types of mass analyser are possible.

It should be noted that FIG. 1 is merely schematic, and that the instrument can, and in embodiments does, include any number of one or more additional components such as ion optical devices. For example, the instrument may include one or more ion transfer stage(s) arranged between any of the illustrated components, e.g. including an atmospheric pressure interface and/or one or more ion guides, lenses and/or other ion optical devices configured such that some or all of the ions can be transmitted appropriately through the instrument. The ion transfer stage(s) may include any suitable number and configuration of ion optical devices, for example optionally including one or more ion guides, lenses and/or other ion optical devices.

In some embodiments, the instrument may include more than one mass analyser. For example, the instrument may be a dual mass analyser hybrid mass spectrometer of the type described in EP 3,410,463, the contents of which are incorporated herein by reference. Numerous other types of dual mass analyser hybrid mass spectrometer are possible.

As also shown in FIG. 1, the instrument is under the control of a control unit 50, such as an appropriately programmed computer, which controls the operation of various components of the instrument and, for example, sets the voltages to be applied to the various components of the instrument. The control unit 50 may also receive and process mass spectral data from various components including the analyser(s). The control unit 50 also includes a memory 51 for storing processed mass spectral data.

The instrument may be operable in various mode of operation. In particular, the instrument may be a tandem mass spectrometer operable in an MS1 mode of operation and an MS2 mode of operation.

In the MS1 (or “full mass scan”) mode of operation, the mass filter 20 is operated in its transmission mode of operation and the fragmentation device 30 is operated in its non-fragmentation mode of operation, e.g. so that a wide m/z range (e.g. full mass range) of unfragmented (“precursor” or “parent”) ions are analysed by the analyser 40 to produce an MS1 spectrum.

In the MS2 mode of operation, the mass filter 20 is operated in its filtering mode of operation and the fragmentation device 30 is operated in its fragmentation mode of operation, e.g. so that a selected narrow m/z range of precursor ions are fragmented and the resulting fragment (“product” or “daughter”) ions are analysed by the analyser 40 to produce an MS2 spectrum.

The instrument may also be operable in one or more higher order fragmentation modes of operation, such as for example an MS3 mode of operation, whereby precursor ions are fragmented, at least some of the resulting fragment ions are themselves fragmented, and the second-generation fragment ions (“granddaughter ions”) are analysed by the analyser 40 produce an MS3 spectrum. In general, the instrument may be operable in any order of fragmentation mode of operation, i.e. in an MS^{N} mode of operation where N≥2.

A method of operating the analytical instrument involves providing a sample to the chromatographic (e.g. LC or GC) separation device so that the sample is chromatographically separated, ionising the eluent from the chromatographic separation device in the ion source 10, and analysing the resulting ions. Different compounds within the sample experience different retention times (RT) within the chromatographic separation device and so elute from the chromatographic separation device (and are ionised) at different times. The chromatographic separation device typically takes a few tens of seconds or a few minutes to complete each chromatographic separation scan.

During each chromatographic separation scan, multiple MS2 spectra (or, more generally, multiple MS^{N} spectra) may be acquired by sequentially altering the centre of the mass filter's (narrow) m/z window between each of a plurality of different m/z values, e.g. so as to sequentially select (and fragment) each of a plurality of different precursor ions with respective different m/z.

In a data dependent acquisition (DDA) mode of operation, the plurality of different m/z values may correspond to a plurality of different precursor ions identified from corresponding MS1 data (i.e. a full mass scan). Thus, a typical data dependent acquisition (DDA) method involves repeatedly performing, during a chromatographic separation scan, the steps of: (i) obtaining an MS1 spectrum across an m/z range of interest; (ii) identifying one or more precursor ions of interest in the MS1 spectrum; and (iii) obtaining an MS2 (or MS^{N}) spectrum in respect of each the identified precursor ions of interest. Step (iii) comprises, for each of the identified precursor ions: isolating the precursor ion using the mass filter 20, fragmenting the isolated precursor ions in the fragmentation device 30, and mass analysing the fragment ions using the mass analyser 40.

In a data independent acquisition (DIA) MS2 (or MS^{N}) mode of operation, the plurality of different m/z values may be taken from a predetermined (fixed) list, i.e. without reference to MS1 data. For example, a narrow m/z isolation window may be sequentially stepped across the entire m/z range of interest, e.g. as described in EP 3,410,463.

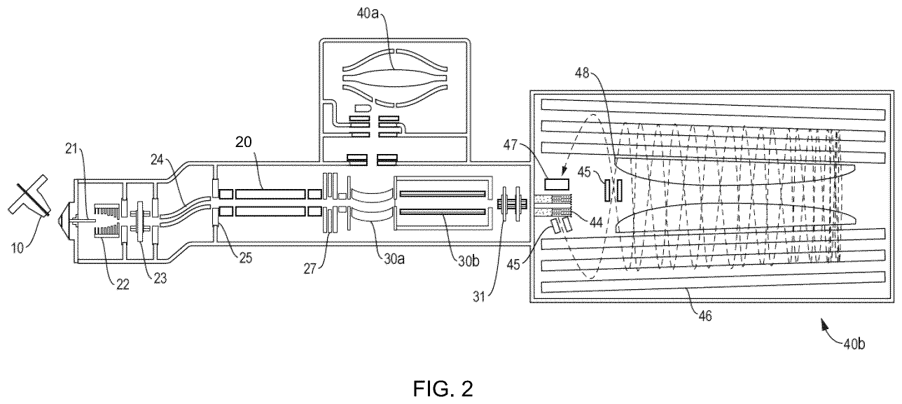

FIG. 2 illustrates schematically detail of one exemplary mass spectrometer including an MR-ToF mass analyser that may be configured and operated in accordance with embodiments. It will be understood that the instrument shown in FIG. 2 is one non-limiting example, and that numerous variations are possible.

In the embodiment depicted in FIG. 2, the instrument's ion source 10 is an electrospray ionisation (ESI) ion source. The instrument includes a vacuum interface, which includes a transfer tube 21, an ion funnel 22, a quadrupole pre-filter ion guide 23, and a “bent flatapole” ion guide 24. The bent flatapole ion guide 24 may be of the design described in U.S. Pat. No. 9,536,722, for example.

The instrument also includes a mass filter in the form of a quadrupole mass filter 20, an ion trap 30a in the form of a curved linear ion trap (“C-Trap”), and a collision cell 30b in the form of an ion routing multipole collision cell (“IRM”). Ions from the ion source 10 can be accumulated in the C-Trap 30a and/or collision cell 30b by opening and closing a gating electrode located in a charge detector assembly 27, which is arranged between the C-Trap 30a and the mass filter 20.

The instrument also includes a first mass analyser 40a in the form of an orbital ion trap mass analyser, particularly an Orbitrap™ mass analyser. Once accumulated in the ion trap 30a and/or collision cell 30b, ions can be ejected into the mass analyser 40a. To do this, the ions may be ejected from the trap 30a in a direction orthogonal to the axis of the trap (orthogonal ejection), for example by applying one or more suitable DC voltages to the ion trap 30a.

The collision or reaction cell 30b is arranged downstream of the ion trap 30a. Ions collected in the ion trap 30a can either be ejected orthogonally to the mass analyser 40a without entering the collision or reaction cell 30b, or the ions can be transmitted axially to the collision or reaction cell 30b for processing before returning the processed ions to the ion trap 30a for subsequent orthogonal ejection to the mass analyser 40a. The processing may comprise, for example, fragmenting the ions by collisions with a collision gas and/or a reagent in the collision cell 30b, or further cooling the ions by collisions with a gas at lower energies that do cause the ions to fragment.

The instrument also includes a second mass analyser 40b in the form of a multi-reflection time-of-flight (MR-ToF) mass analyser, which has been added to the rear of the instrument. This hybridised instrument is described in more detail, for example in U.S. Pat. No. 10,699,888.

As shown in FIG. 2, the instrument includes a multipole ion guide 31 to allow ions to be transferred from the collision cell 30b to the time-of-flight mass analyser 40b. Ions are delivered from the collision cell 30b to the extraction trap 44 of the mass analyser 40b via the multipole ion guide 31. The ions are accumulated and cooled in the extraction trap 44.

The extraction trap 44 may incorporate two trapping regions, one at a relatively higher pressure for rapid ion cooling, and a second low pressure region for ion extraction. Ions are cooled in the high-pressure region and then transferred to the low-pressure region, where they are pulse ejected into the ToF analyser via the pair of deflectors 45. Ions oscillate between the pair of mirrors 46, which are tilted relative to one another so that the ion path is slowly deflected and redirected back to the detector 47. Correcting stripe electrodes 48 counter the loss of ion focus otherwise induced by the non-parallelism of the mirrors.

The instrument depicted in FIG. 2 is described in more detail, e.g., in the article Stewart, H. et al. Anal. Chem. 2023, 95 (42), 15656-15664.

Although the mass spectrometer depicted in FIG. 2 is particularly suitable, it will be understood that numerous alternative mass spectrometer configurations are possible. For example, although in FIG. 2, the ToF mass analyser 40b is of a tilted-mirror type as described in US patent No. 9, 136, 101, it will be understood that any type of ToF analyser could be used. For example, the analyser may be a single-lens type multireflection time-of-flight mass analyser, e.g. as described in UK Patent No. GB 2,580,089, a linear ToF mass analyser, an orthogonal acceleration ToF mass analyser, a reflectron ToF mass analyser, a closed-loop multi-reflection mass analyser, another type of multi-reflection time-of-flight (MR-ToF) analyser, etc.

More generally, the mass spectrometer depicted in FIG. 2 has two mass analysers 40a, 40b, but the mass spectrometer could have only a single mass analyser or could have more than two mass analysers. In the instrument depicted in FIG. 2, the two mass analysers are in the form of a ToF mass analyser 40b and an orbital ion trap mass analyser 40b, but in general any type or types of mass analyser could be provided.

Mass analysers necessarily compromise on different aspects of their performance, and each has a different performance envelope. For example, the orbital trapping mass analyser 40a can slowly generate very high resolution, mass accurate spectra, while the MR-ToF mass analyser 40b cannot quite match the orbital trapping analyser in these regards but is much faster and more sensitive.

In the instrument shown in FIG. 2, the two analysers have been combined to enhance instrument performance: the orbital trapping analyser 40a is used to make high quality analyte survey (“MS1”) scans (“Full-MS”) while the MR-ToF analyser 40b operates in parallel to generate rapid and sensitive MS/MS (“MS2”) fragmentation scans, that fingerprint the analytes and allow for their identification. Another family of multi-analyser hybrid instruments are the Tribrid™ mass spectrometers (Senko, M. et al. Anal Chem, 2013, 85 (24), 11710-11714), that combine an orbital trapping analyser and an extremely sensitive ion trap analyser, along with a quadrupole mass filter.

In addition, differing analyser settings or modes of operation will change analyser performance. For example, the orbital trapping analyser 40a has resolving power and signal to noise ratio that depend on the transient time, or length of analysis. There is therefore a trade-off between quality and repetition rate. Changing the amplitude of the RF voltage applied to the C-Trap 30a (that accumulates ions and injects them into the orbital trapping analyser 40a) will change the m/z range that can be efficiently trapped. Increasing the gain of the ion detector 47 might increase the sensitivity to low lying signals but will reduce the number of ions at which signal saturation takes place.

As mentioned above, a typical method of operating a mass spectrometer involves taking Full-MS (MS1) survey scans of the injected analyte ions together with large numbers of MS/MS (MS2) fragment scans of isolated individual m/z ranges of analytes for their identification. In data dependent acquisition (DDA), the survey scans are used to define targets for MS/MS (MS2) analysis, while in data independent acquisition (DIA), the target m/z ranges are preprogrammed. In instruments having a single mass analyser in the form of an orbital trapping mass analyser, the orbital trapping mass analyser is typically used in a high-quality mode for Full-MS scans, and in a high-speed mode for the large number of MS/MS scans to maximise coverage. Modern bioanalytical software uses a mixture of data (e.g., m/z, relative intensities, etc.) from both Full-MS and MS/MS data to identify and quantify analytes. For example, one may use MS/MS peaks for quantitation, but also Full-MS peaks to provide the precursor m/z value for identification.

Although mass spectrometers typically record profile data, showing the shape of peaks, what generally matters for downstream analytical software is the centroid data that is generated from these profiles. In principle, each peak should have a resultant centroid showing m/z and intensity, with further annotation possible such as resolving power, polarity, charge state, collision cross section (e.g. if mobility analysis is possible, as it is in some special Orbitrap™ analyser methods (Sanders, J. D. et al. Anal. Chem. 2018, 90 (9), 5896-5902)), signal/noise, and additional peak fidelity flags to denote the possibility of errors such as harmonics or electronic/chemical noise. In most applications, it is not necessarily important that the instruments provide true spectra, but rather the instrument should provide the most informative and representative list of peaks possible.

As mentioned above, different mass analysers or different operation settings can produce large changes in particular performance parameters. There is always some level of compromise, or a fundamental shortfall, that limits one or more aspects of instrument performance. There are the common limitations of resolution, sensitivity and dynamic range, but also more niche problems such as peak attenuation by destructive interference for closely packed or multiply charged ions in FT and Orbitrap™ mass analysers, a whole range of spectral artifacts produced by Fourier transform, ringing of common ion detectors, and electronic interferences.

Embodiments provide a method in which data from two data sources are combined to generate a superior whole. Rather than simply removing or replacing entire spectral features, specific properties of the features are selected from each one of the data sources.

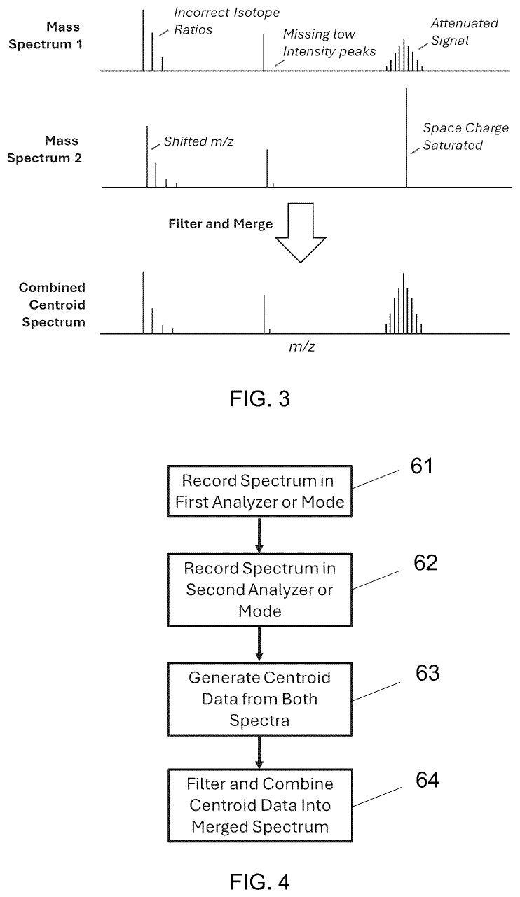

FIG. 3 shows two example mass spectra of the same ion population taken by different mass analysers. Mass spectrum 1 101 illustrates the weaknesses of a Fourier Transform (FT) mass analyser, with isotope ratios distorted by faster signal decay rates at low intensities, attenuation of multiply charged protein ion signals due to interference effects and missing low intensity peaks. Mass spectrum 2 102 illustrates problems associated with ion-trap time-of-flight (ToF) mass analysers, including shifted m/z from noise and space charge saturation of intense features.

In accordance with embodiments, taking the peak centroids of both spectra and choosing the peak annotations with the highest quality values allows one to generate a centroid spectrum with corrected m/z, isotope ratios and high sensitivity. This is illustrated by the bottom example mass spectrum in FIG. 3.

The attenuated multiple ion signal may be corrected with a slightly more complex step: splitting the space charge saturated peak intensity (from mass spectrum 2) between the attenuated cluster m/z and relative distribution (from mass spectrum 1).

The correction algorithm may take account of differences between image current detection (i.e. detection of interfering waveforms) versus secondary electron detection (i.e. destructive detection of ions). For example, the former is characterised by so-called isotope beating effects for molecules with multiple isotopic peaks such as proteins, DNA, etc. (S. A. Hofstadler et al.; Int. J. Mass Spectrom. Ion Processes; 132 (1994) 109-127). Meanwhile, the latter suffers from strong velocity dependence of incoming ions, resulting in reduced detection efficiency of high-mass ions.

A simple general process for operating an analytical instrument in accordance with embodiments is shown in FIG. 4. Two spectra are recorded (steps 61 and 62), either one in each analyser, or in the case of a single analyser instrument, one in either of two modes of operation. Centroid data are then generated from both spectra, appropriately annotated and flagged (step 63), and a merged spectrum is formed by filtering centroid data and combining or excluding it to form a merged spectrum (step 64).

Filtering requires matching features from the two spectra, to avoid duplication, which may for example be performed based on similarity of m/z and intensity.

Peaks in one spectrum that have no match to another may result from a specific failure of one data source (such as artefacts, low sensitivity or space charge effects), which should be identifiable based on the intensity, m/z and charge state of the detected peak. The choice of whether to include such peaks or not in the final spectrum becomes obvious once their nature is identified: artefacts go out, while low lying or unresolved peaks go in (with appropriate correction to intensity).

The combination of data within each matching centroid pair may be made based on which data source is preferred, and/or based on the properties of the centroids, and/or based of properties of surrounding centroids. For example, where the instrument combines two analysers, intensity should not generally be chosen from the analyser with poor signal/noise, or the analyser which is likely to be saturated. Intensities should also be scaled so that analysers match; intensity in terms of estimated ion current is typically the best. In some embodiments, a corresponding AI model may be trained, e.g. on millions of spectra acquired for known compounds.

The method depicted in FIG. 4 can be integrated into a larger method. For example, it may be used for the regular MS1 survey scan(s) in DDA or DIA cycles, while the MS/MS (MS2) scans continue as normal without this method.

Embodiments can be applied to the mass spectrometer shown in FIG. 2, which is capable of recording matching spectra in both analysers.

When combining centroid data, it is beneficial to recognise what advantages each analyser has and where one would generally prefer to draw a centroid annotation from. Table 1 shows approximate Full-MS performance and limitations for a number of characteristics of the FIG. 2 instrument, including resolving power, mass accuracy, intensity and associated isotope ratio accuracy, among others. The better analyser of the two (most commonly the Orbitrap™ analyser) is then preferred for that particular centroid annotation.

Note that some centroid properties may exceed a threshold where one analyser may become worse when it is normally better (for example where Astral™ analyser peaks under space charge lose resolving power and start to overlap), but it should be possible to detect and filter these if there is not already an intensity filter.

TABLE 1
Example differences in mass spectral performance between Orbitrap ™ analyser
and Astral ™ analyser, and recommended combination of centroid data.

| Property | Orbitrap ™ Analyser | | Astral ™ Analyser | | Final Centroids |
|---|---|---|---|---|---|
| Resolving | 240,000 | | 80,000 | | OT |
| Power | | | | | |
| Mass Accuracy | <3 | ppm | <5 | ppm (jitter) | OT |
| Ion Count and | Distorted by | | Distorted by | | Astral ™ analyser |
| Isotope Ratios | interferences & at | | saturation effects | | (resolved peaks). |
| | lower S/N | | and mass | | |
| | | | dependence | | |
| Charge State | Proven detection | | Saturation/ion | | OT |
| | accuracy | | statistical limits. | | |
| In-Peak Space | 5000-20000 | ions | 500-1000 | ions | OT (intense |

| | | | |
|---|---|---|---|
| Charge limit | | | peaks) |
| Low Level | Requires multiple | Single ion | Astral ™ analyser |
| Peaks | elementary charges | sensitivity | |
| | in a peak | | |
| Collision Cross | Measurable | N/A | OT |
| Section | | | |

In some embodiments, FTMS (e.g. Orbitrap™ analyser) relative intensities are corrected based on values acquired by a second mass analyser (e.g. Astral™ analyser) (or vice versa). In some embodiments, masses acquired by FTMS (e.g. Orbitrap™ analyser) are corrected based on those acquired by a second mass analyser (e.g. Astral™ analyser) (or vice versa).

Embodiments can be used to enhance isotopic ratio measurements. For example, a panoramic Orbitrap™ analyser spectrum may contain A0, A1 and low-s/n A2 isotopes of compounds of interest. From the A1/A0 ratio, 13C, 2H and 15N isotope abundances may be determined. Meanwhile, for Astral™ analyser acquisition, a quadrupole mass filter may be activated to transmit only the A1, A2, A3, etc. isotopes. Due to the Astral™ analyser's superior sensitivity, it can acquire better statistics faster for each of those isotopes, although not necessarily while separating 13C from 15N in A1, but most likely separating 34S from 2*13C in the A2 isotope. Then, information from the Orbitrap™ analyser spectrum could be used to deconvolute unresolved peaks from the Astral™ analyser acquisition.

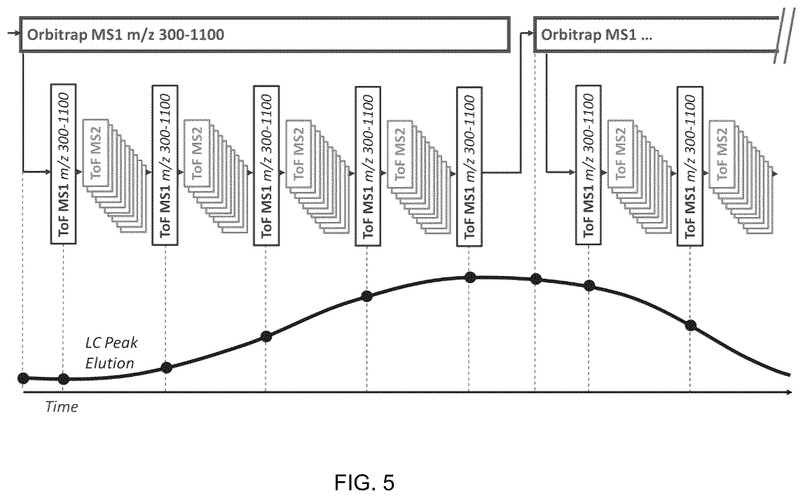

FIG. 5 illustrates a method 200 of operating the instrument of FIG. 2 in accordance with embodiments, in which Orbitrap™ analyser scans are combined with frequent Astral™ analyser full-MS scans and MS/MS scans. High quality Orbitrap™ analyser scans are relatively slow and have a long processing overhead, while ToF or Astral™ analyser scans are extremely fast. For time-dependent actions such as forming the precursor list (essentially a filtered full-MS centroid spectrum) for data dependent MS/MS scans, the Astral™ analyser is much better at providing representative intensities due to its ability to measure frequently and provide results rapidly.

In the experiment illustrated in FIG. 5, the Astral™ analyser produces frequent precursor measurements, while the Orbitrap™ analyser makes relatively slow, high-quality analyses. In this case the most recent Astral™ analyser intensity data may be appended to the accurate Orbitrap™ analyser centroids, or averaged centroid m/z values may be used with the most recent single shot intensity values. This allows improved tracking of the intensity across a chromatographic peak.

It will be understood that embodiments provide a method in which processed centroid (stick plot) data and metadata are combined. This is in contrast with known methods of selecting peaks or raw datapoints themselves.

Embodiments allow the best performance parameters of differing analysers or modes of operation to be combined, so as to create high quality mass spectra. Rather than just an improvement in terms of dynamic range or saturation effects, embodiments allow parameters such as isotope ratios, resolution, intensity and mass accuracy to be optimised, while specific bad data points may be filtered out and replaced. In particular, the accuracy and resolution of the Orbitrap™ analyser at its best may be combined with the sensitivity of data from an ion trap mass analyser or the Astral™ analyser.

Embodiments provide another advantage in terms of data compression by filtering out or combining otherwise redundant data.

Although various particular embodiments have been described above, numerous alternatives are possible.

In general, centroid data may be combined from different analysers, for example Orbitrap™, ToF, Astral™, ion trap, or quadrupole analysers. Centroid data may also or instead be combined from separate channels in the same analyser, such as where the signal is split into separate channels, or where signals are produced by multiple detectors. They may further still be combined from different scans in the same analyser taken under different conditions, for example long and short transients, or high and low ion loading, or with and without methods like phase space cutting that improve resolving power at the cost of transmission, and so on. Different analyte conditions may be used, such as combining MS and MS/MS data.

Filters may be provided to detect when centroid data from one source is substandard, based on for example saturation (high intensity), poor ion statistics, space charge effects or interferences. One data source may be used to detect artefacts produced by the other.

Although particular embodiments are concerned with centroid data, in some embodiments similar effects may be achieved by scaling profile data points for specific features. For example, the m/z correction for a ToF feature based on a matching Orbitrap™ analyser feature may be made by shifting the data points of the feature based on the difference between centroids, and then the ToF centroid may be recalculated. The same action may be performed for relative or absolute intensity.

Although the present invention has been described with reference to various embodiments, it will be understood that various changes may be made without departing from the scope of the invention as set out in the accompanying claims.

What is claimed is:

1. A method of processing mass spectral data that comprises a first set of mass spectral data acquired from a first source of mass spectral data and a second set of mass spectral data acquired from a second source of mass spectral data, the method comprising:
identifying one or more ion peaks in the first set of mass spectral data, and for each of one or more ion peaks identified in the first set of mass spectral data: determining value(s) of one or more first properties of that ion peak;
identifying one or more ion peaks in the second set of mass spectral data, and for each of one or more ion peaks identified in the second set of mass spectral data:
determining value(s) of one or more second properties of that ion peak;
identifying one or more features in the mass spectral data by comparing peak(s) identified in the first set of mass spectral data with peak(s) identified in the second set of mass spectral data; and
storing data describing each identified feature;
wherein, for at least one identified feature that comprises one or more first ion peak(s) identified in the first set of mass spectral data and one or more corresponding second ion peak(s) identified in the second set of mass spectral data, the step of storing data comprises: storing value(s) of at least one property of the one or more first properties and value(s) of at least one different property of the one or more second properties to describe the at least one identified feature;
wherein the step of storing data comprises: storing centroid value(s) as determined from the first set of mass spectral data and storing intensity value(s) as determined from the second set of mass spectral to describe the at least one identified feature.

2. The method of claim 1, wherein the first and second sets of mass spectral data are acquired substantially in parallel in respect of the same sample and/or the same flow of ions.

3. The method of claim 1, wherein:
the first source of mass spectral data comprises a mass analyser having a mass accuracy ≤about 100 ppm and a resolving power ≥about 5,000; and
the second source of mass spectral data comprises a mass analyser having a mass accuracy ≤about 100 ppm and a resolving power ≥about 5,000.

4. The method of claim 1, wherein the first source of mass spectral data comprises a first mass analyser of a first type and the second source of mass spectral data comprises a second mass analyser of a second different type.

5. The method of claim 1, wherein:
the first source of mass spectral data comprises a first mass analyser of a first type operated in a first mode of operation; and
the second source of mass spectral data comprises: (i) the first mass analyser operated in a second different mode of operation; or (ii) a second mass analyser of the first type operated in a second different mode of operation.

6. The method of claim 4, wherein:
the first mass analyser type comprises a Fourier Transform (FT) mass analyser, an ion trap mass analyser, an electrostatic orbital trap mass analyser, a time-of-flight (ToF) mass analyser, a multi-reflecting time-of-flight (MR-ToF) mass analyser, or a quadrupole mass analyser; and/or
the second mass analyser type comprises a Fourier Transform (FT) mass analyser, an ion trap mass analyser, an electrostatic orbital trap mass analyser, a time-of-flight (ToF) mass analyser, a multi-reflecting time-of-flight (MR-ToF) mass analyser, or a quadrupole mass analyser.

7. The method of claim 4, wherein the first mass analyser is a Fourier Transform (FT) mass analyser, and the second mass analyser is a time-of-flight (ToF) mass analyser or a multi-reflecting time-of-flight (MR-ToF) mass analyser.

8. The method of claim 1, wherein the at least one property of the one or more first properties and the at least one different property of the one or more second properties are selected based on relative performance of the first and second sources of mass spectral data.

9. The method of claim 1, wherein the step of identifying one or more features in the mass spectral data comprises, for each of one or more ion peaks identified in the first set of mass spectral data:
determining whether the ion peak corresponds to one or more ion peak(s) identified in the second set of mass spectral data; and
identifying a feature when it is determined that an ion peak identified in the first set of mass spectral data corresponds to one or more ion peak(s) identified in the second set of mass spectral data.

10. The method of claim 9, further comprising when it is determined that an ion peak identified in the first set of mass spectral data does not correspond to any ion peak identified in the second set of mass spectral data: determining whether the ion peak identified in the first set of mass spectral data is a feature or an artefact.

11. The method of claim 10, further comprising:
when it is determined that the ion peak is a feature, storing a value of at least one property of the one or more first properties to describe the feature; and/or
when it is determined that the ion peak is an artefact, discarding the ion peak without storing any data.

12. The method of claim 1, wherein the feature comprises a single first ion peak identified in the first set of mass spectral data and a single corresponding second ion peak identified in the second set of mass spectral data, and the method comprises storing data describing the feature as a single peak, the data comprising a value of the at least one property of the one or more first properties and a value of the at least one different property of the one or more second properties to describe the single peak.

13. The method of claim 1, wherein:
the feature comprises one or more first ion peak(s) identified in the first set of mass spectral data and a plurality of corresponding second ion peaks identified in the second set of mass spectral data, or the feature comprises a plurality of first ion peaks identified in the first set of mass spectral data and one or more corresponding second ion peak(s) identified in the second set of mass spectral data; and
the method comprises storing values of the at least one property of the one or more first properties for all peaks in the feature and storing values of the at least one different property of the one or more second properties for all peaks in the feature.

14. The method of claim 1, wherein the method comprises:
not determining value(s) of the at least one property of the one or more first properties based on the second set of mass spectral data and/or not determining value(s) of the at least one different property of the one or more second properties based on the first set of mass spectral data; and/or
discarding any value(s) of the at least one property of the one or more first properties determined based on the second set of mass spectral data and/or discarding any value(s) of the at least one different property of the one or more second properties determined based on the first set of mass spectral data.

15. The method of claim 1, wherein the first set of mass spectral data is acquired with a first acquisition rate, and the second set of mass spectral data is acquired with a second acquisition rate, wherein the second acquisition rate is greater than the first acquisition rate.

16. The method of claim 15, wherein the method further comprises:
identifying one or more ion peaks in one or more third set(s) of mass spectral data acquired from the second source of mass spectral data, and for each of one or more ion peaks identified in each third set of mass spectral data: determining value(s) of one or more second properties of that ion peak; and
updating the stored data describing the least one identified feature by storing intensity value(s) as determined from each third set of mass spectral to describe the at least one identified feature.

17. The method of claim 1, wherein:
the at least one identified feature comprises a plurality of first ion peaks that correspond to an isotopic cluster, and one or more corresponding second ion peak(s); and
the method comprises:
storing centroid values for each of the plurality of first ion peaks as determined from the first set of mass spectral data;
determining a total intensity value for the one or more second ion peak(s);
distributing the determined total intensity value among the plurality of first ion peaks to determine an intensity value for each of the plurality of first ion peaks; and
storing the determined intensity value for each of the plurality of first ion peaks.

18. A method of mass spectrometry comprising:
ionising a sample to produce sample ions;
mass analysing the sample ions or ions derived from the sample ions to obtain a first set of mass spectral data;
mass analysing the sample ions or ions derived from the sample ions to obtain a second set of mass spectral data; and
processing the mass spectral data using the method of claim 1.

19. An analytical instrument comprising:
an ion source configured to ionise a sample to produce sample ions;
one or more mass analyser(s) configured to mass analyse sample ions or ions derived from sample ions to acquire mass spectral data comprising a first set of mass spectral data acquired from a first source of mass spectral data and a second set of mass spectral data acquired from a second source of mass spectral data; and
a control system configured to process the mass spectral data by:
identifying one or more ion peaks in the first set of mass spectral data, and for each of one or more ion peaks identified in the first set of mass spectral data: determining value(s) of one or more first properties of that ion peak;
identifying one or more ion peaks in the second set of mass spectral data, and for each of one or more ion peaks identified in the second set of mass spectral data:
determining value(s) of one or more second properties of that ion peak;
identifying one or more features in the mass spectral data by comparing peak(s) identified in the first set of mass spectral data with peak(s) identified in the second set of mass spectral data; and
storing data describing each identified feature;
wherein, for at least one identified feature that comprises one or more first ion peak(s) identified in the first set of mass spectral data and one or more corresponding second ion peak(s) identified in the second set of mass spectral data, the step of storing data comprises: storing value(s) of at least one property of the one or more first properties and value(s) of at least one different property of the one or more second properties to describe the at least one identified feature;
wherein the step of storing data comprises: storing centroid value(s) as determined from the first set of mass spectral data and storing intensity value(s) as determined from the second set of mass spectral to describe the at least one identified feature.
